(19) United States
(12) Patent Application Publication
(10) Pub. No.: US 2006/0068900 A1
(43) Pub. Date: Mar. 30, 2006

(54) Gaming machine having rotatable bodies

(76) Inventor: Allon G. Englman, Chicago, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/228,877

(22) Filed: Sep. 16, 2005

Related U.S. Application Data
(60) Provisional application No. 60/610,376, filed on Sep. 16, 2004.

(51) Int. Cl. A63F 13/00

(52) U.S. Cl. 463/25

(57) ABSTRACT

A gaming machine for conducting a wagering game includes at least one rotatable three-dimensional body. The basic game includes a plurality of standard symbols and at least one second-chance symbol. The three-dimensional body bears at least one of a standard symbols from the game and an enhanced award symbol. Upon the occurrence of certain winning combinations of symbols in the game that includes the display of at least one second-chance symbol, the three-dimensional body is actuated and stopped to reveal a standard symbol of the basic game. If the standard symbol of the three-dimensional body along with the standard symbols displayed in the game complete a winning combination, an award is provided to the player.

### CROSS-REFERENCE TO RELATED APPLICATION

This application claims the benefit of the U.S. Provisional Application 60/610,376 filed on Sep. 16, 2004 and entitled “Gaming Machine Having Rotatable Bodies” and this provisional application is hereby incorporated by reference in its entirety.

### FIELD OF THE INVENTION

The present invention relates generally to gaming machines and, more particularly, to a gaming machine having at least one rotatable body bearing at least one symbol from a game displayed on the gaming machine.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator.

One concept which has been successfully employed to enhance the entertainment value of a game is the concept of a “secondary” or “bonus” game which may be played in conjunction with a “basic” game. The bonus game may comprise any type of game, either similar to or completely different from the basic game, which is entered upon the occurrence of a selected event or outcome of the basic game. Generally, bonus games provide a greater expectation of winning than the basic game and may also be accompanied with more attractive or unusual video displays and/or audio. Because the bonus game concept offers tremendous advantages in player appeal and excitement relative to other known games, and because such games are attractive to both players and operators, there is a continuing need to develop gaming machines with new types of bonus games to satisfy the demands of players and operators.

Gaming machines have utilized a variety of mechanical objects to either augment the basic game played on the gaming machine, or to constitute a bonus game on the gaming machine. However, traditional uses of these mechanical objects have been largely for ancillary purposes such as displaying game advertising, game features or performing other entertaining portions of game play. Traditional mechanical objects on gaming machines have generally failed, however, to share symbols from the basic game to offer the player a multitude of additional gameplay features in the way of bonuses, extra plays, or second chance wins. Thus, a need exists for a gaming machine having a rotatable body that bears symbols corresponding to those in the basic game of the gaming machine. A need also exists for the body to function in conjunction with the basic game to award bonuses, extra plays, and/or second chances to the player. The present invention is directed to satisfying these needs and solving other problems.

### SUMMARY OF THE INVENTION

In accordance with the foregoing, a gaming machine for conducting a wagering game includes a primary display for displaying the wagering game. The gaming machine is controlled by a processor. The primary display displays the play of at least the basic game of the gaming machine. The gaming machine further includes at least one rotatable body bearing at least one symbol from the basic game. According to one aspect of the invention, the body is a cube.

According to another aspect of the invention, the gaming machine includes a plurality of rotatable bodies. Preferably, the basic game is a slot game, and the number of bodies corresponds to the number of reels in the slot game.

According to yet another aspect of the invention, the basic game includes a plurality of symbols. At least one of the symbols is a standard symbol, and at least one of the symbols is a second-chance symbol which initiates rotation and play of the body. The rotatable body bears at least one standard symbol which is used in combination with the standard symbols in the basic game to provide the player with a second chance at achieving a winning outcome.

According to yet another aspect of the invention, the rotatable body bears the same plurality of standard symbols as the basic game, and rotates with every play of the basic game. In this way, the body serves to display one of a plurality of symbols that can be used in combination with standard symbols from the basic game to provide a different variety of winning combinations.

According to yet another aspect of the invention, the rotatable body bears a plurality of enhanced award symbols, which are preferably multiplier awards. Certain winning combinations of the basic game entitle the player to execute a spin of the body which reveals a multiplier award which is applied to the underlying award of the basic game to multiply and increase the underlying award. Alternatively, a plurality of bodies are rotated simultaneously, with the player selecting at least one body, which stops rotating to display a multiplier award.

According to yet another aspect of the invention, the gaming machine includes a plurality of rotatable bodies that are equal in number to the number of reels in a slot basic game. With each play or spin of the reels in the slot game, the bodies are rotated as well. Each body bears only standard symbols used on the reels in the basic game. Thus, certain combinations of symbols on the bodies may be used in conjunction with certain combinations of symbols on the reels to provide additional awards to a player. For example, if the combination of symbols on the bodies matches the combination of symbols on the reels in the basic game, then a bonus may be awarded to the player. In this way, the plurality of rotatable bodies act as a separate set of “reels.”

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of the gaming machine of the present invention;

FIG. 2 is a block diagram of a control system suitable for operating the gaming machine of FIG. 1;

FIG. 3 is a perspective view of a rotatable body of the gaming machine of FIG. 1;

FIG. 4 is a front view of one embodiment of the gaming machine of the present invention;

FIG. 5 is a front view of a second embodiment of the gaming machine of the present invention;

FIG. 6 is a front view of a third embodiment of the gaming machine of the present invention;

FIG. 7 is a front view of an alternate configuration of the third embodiment of FIG. 6; and

FIG. 8 is a front view of a fourth embodiment of the gaming machine of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

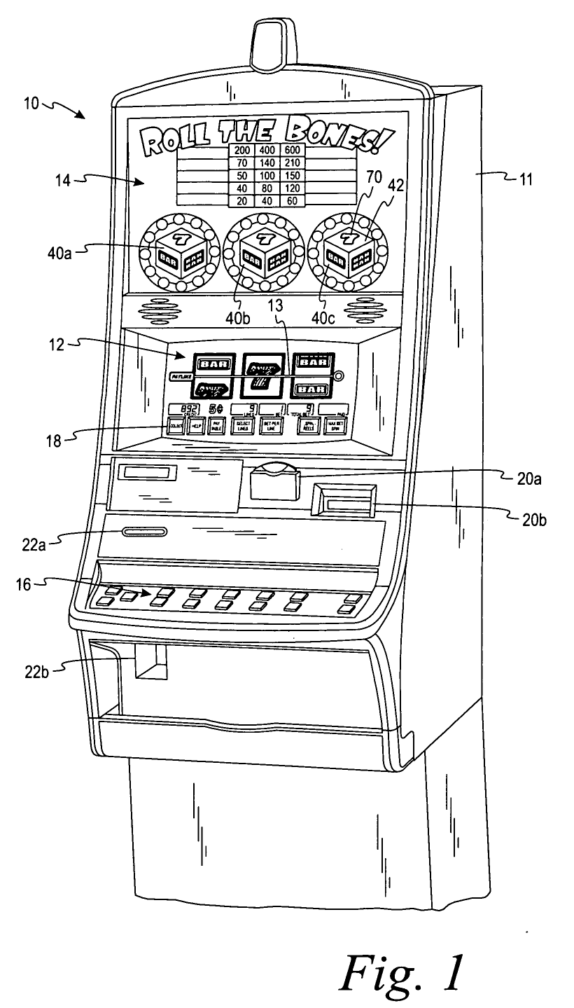

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be a mechanical gaming machine configured to play mechanical slots, or it may be an electromechanical or electrical gaming machine configured to play a video casino game, such as blackjack, slots, keno, poker, etc.

The gaming machine 10 comprises a housing 11 and includes input devices, including a value input device 20 and a player input device 16. For output the gaming machine 10 includes a primary display 12 for displaying information about the basic wagering game. The primary display 12 can also display information about a bonus wagering game and a progressive wagering game. The gaming machine 10 also includes a secondary display 14 for displaying the bonus wagering game, or for displaying award amounts of a progressive game. The gaming machine 10 may also utilize the secondary display 14 for displaying game events, game outcomes, and/or signage information. While these typical components found in the gaming machine 10 are described below, it should be understood that numerous other elements may exist and may be used in any number of combinations to create various forms of a gaming machine 10.

The value input device 20 may be provided in many forms, individually or in combination, and is preferably located on the front of the housing 11. The value input device 20 receives currency and/or credits which are inserted by a player. The value input device 20 may include a coin acceptor 20a for receiving coin currency (see FIG. 1). Alternatively, or in addition, the value input device 20 may include a bill acceptor 20b for receiving cash. Furthermore, the value input device 20 may include a ticket reader, or barcode scanner, for reading information stored on a credit ticket, a card, or other tangible portable credit storage device. The credit ticket or card may also authorize access to a central account, which can transfer money to the gaming machine 10.

The player input device 16 comprises a plurality of push buttons on a button panel for operating the gaming machine 10. In addition, or alternatively, the player input device 16 may comprise a touch screen mounted by adhesive, tape, or the like over the primary display 12. The touch screen contains soft touch keys 18 denoted by graphics on the underlying primary display 12 and used to operate the gaming machine 10. The touch screen provides players with an option on how to make their game selections. A player enables a desired function either by touching the touch screen at an appropriate touch key 18 or by pressing an appropriate push button 16 on the button panel. The touch keys 18 may be used to implement the same functions as push buttons 16. Alternatively, the push button panel 16 provides inputs for one aspect of the operating the game, while the touch screen keys 18 allow for input needed for another aspect of the game.

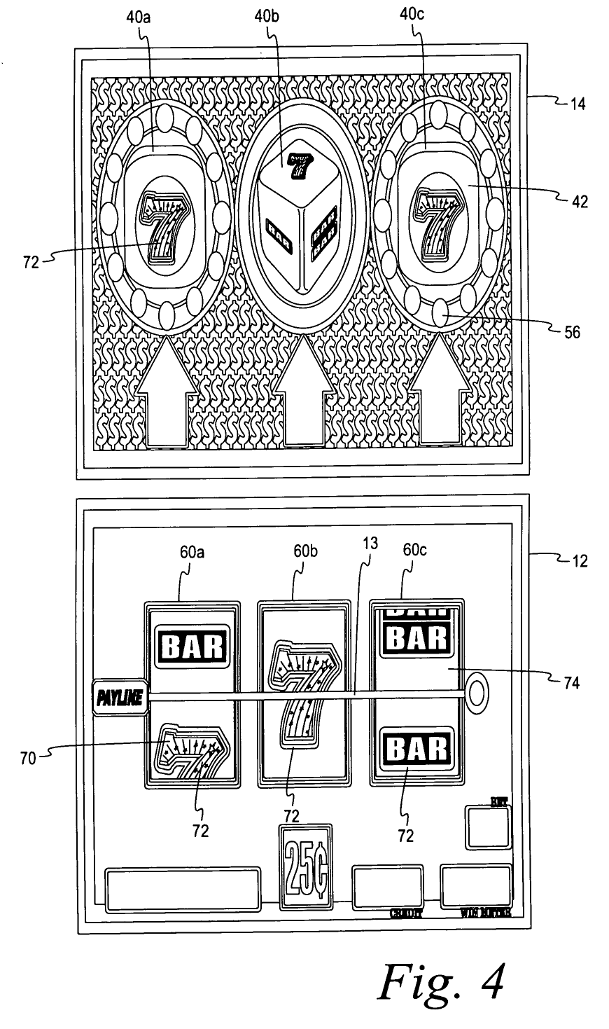

Continuing with FIG. 1, the gaming machine 10 also includes at least one rotatable body 40, preferably mounted on a front side of the housing 11 above the primary display 12. In the embodiment depicted in FIG. 1, the gaming machine 10 includes three rotatable bodies 40a,b,c. Each body 40 is a three-dimensional object having length, width, and depth, and an exterior surface. Preferably the exterior surface of the body 40 comprises a plurality of faces or sides, but the exterior surface of the body 40 may comprise one continuous surface, such as a sphere. In the most preferred embodiment, the body 40 takes the form of a cube. The body 40 is controlled by a processor of the gaming machine 10 to rotate and stop, at different intervals, to display symbols 70 affixed on the various faces, or surfaces 42 of the body 40. The body 40 is operated by the processor 15 in conjunction with the basic game on the primary display 12 to display additional outcomes or plays of the gaming machine 10 (see FIGS. 4-8).

The various components of the gaming machine 10 may be connected directly to, or contained within, the housing 11, as seen in FIG. 1, or may be located outboard of the housing 11 and connected to the housing 11 via a variety of different connection methods well known in the art, including network connections, wireless connections, or other hardwired or remote connections. Thus, the gaming machine 10 comprises these components whether housed in the housing 11, or outboard of the housing 11 and connected remotely. Preferably, the primary display 12, secondary display 14, value input device 20, player input device 16, and body 40 of the gaming machine 10 are visible from outside of the housing 11 of the gaming machine 10, as seen in FIG. 1.

The operation of the basic wagering game is displayed to the player on the primary display 12. The primary display 12 can also display the bonus game associated with the basic wagering game. The primary display 12 may take the form of a cathode ray tube (CRT), a high resolution LCD, a plasma display, an LED display, or any other type of video display suitable for use in the gaming machine 10. As shown, the primary display 12 includes the touch screen overlaying the entire monitor (or a portion thereof) to allow players to make game-related selections. Alternatively, the gaming machine 10 may have a number of mechanical reels to display the outcome. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

A player begins play of the basic wagering game by inserting a wager input into the value input device 20 of the gaming machine 10. A player can select play by using the player input device 16 or the touch screen keys 18. The basic game consists of a plurality of symbols on reels that are displayed along at least one payline 13, yielding a plurality of outcomes of the basic game. Such outcomes are randomly selected in response to the wagering input by the player. At least one of the plurality of randomly-selected outcomes is a start-bonus outcome, which can include any variations of symbols or symbol combinations triggering a bonus game.

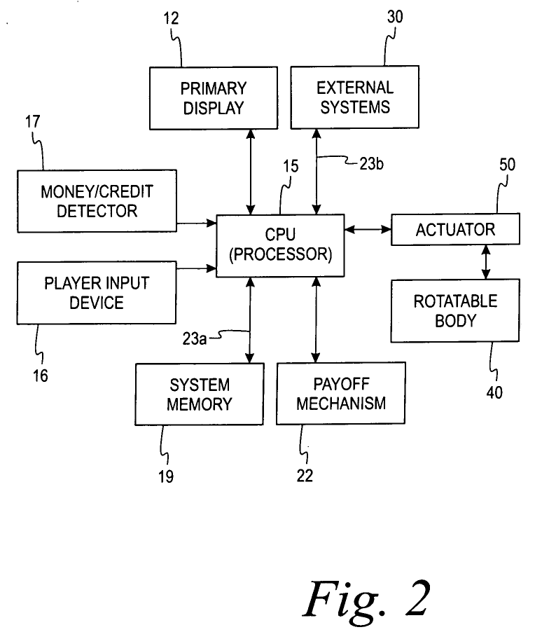

Turning now to FIG. 2, the various components of the gaming machine 10 are controlled by a central processing unit (CPU) 15, also referred to as a processor (such as a microprocessor or microcontroller). To provide gaming functions, the processor 15 executes one or more game programs. The processor 15 performs the random selection (using a random number generator (RNG)) of an outcome from the plurality of outcomes of the wagering game. Alternatively, the random event may be generated remotely at a remote computer. The remote computer may use either an RNG or pooling schema for its central determination of a game outcome. It should be appreciated that the processor 15 may include one or more microprocessors, including but not limited to a master processor, a slave processor, and a secondary or parallel processor.

The processor 15 is also coupled to or includes a system memory 19 and a money/credit detector 17. The system memory 19 may comprise a volatile memory (e.g., a random-access memory (RAM)) and a non-volatile memory (e.g., an EEPROM). The money/credit detector 17 signals the processor that money and/or credits have been input via the value input device 20. The system memory 19 may include multiple RAM and multiple program memories. Preferably, these components are located within the housing 11 of the gaming machine 10 and not visible externally. However, as explained above, these components may be located outboard of the housing 11 and connected to the remainder of the components of the gaming machine 10 via a variety of different connection methods well known in the art, including network connections, wireless connections, or other hardwired or remote connections.

As seen in FIG. 2, the processor 15 is also connected to, and controls, the primary display 12, the player input device 16, and a pay off mechanism 22. The pay off mechanism 22 is operable in response to instructions from the processor 15 to award a payoff to the player in response to certain winning outcomes that might occur in the basic or the bonus game. The payoff may be provided in the form of points, bills, tickets, coupons, cards, etc. For example, in FIG. 1, the payoff mechanism 22 includes both a ticket printer 22a and a coin outlet 22b. However, any of a variety of pay off mechanisms 22 well known in the art may be implemented, including cards, coins, tickets, smartcards, cash, etc. The pay off amounts distributed by the payoff mechanism 22 are determined by one or more pay tables stored in the system memory 19. The processor 15 is also in communication with an actuator 50, which in turn is connected to the rotatable body 40. In this way, the processor 15 controls the actuator 50 which causes and controls the rotation, speed, intervals, and stopping of the body 40, to display symbols 70 used in conjunction with the basic game, as described in the embodiments herein (See FIGS. 4-8).

Communications between the peripheral components of the gaming machine 10 and the processor 15 occur through input/output (I/O) circuits 23a. As such, the processor 15 also controls and receives inputs from the peripheral components of the gaming machine 10. Further, the processor 15 communicates with external systems 30 via the I/O circuits 23b. Although the I/O circuits 23 may be shown as a single block, it should be appreciated that the I/O circuits 23 may include a number of different types of I/O circuits.

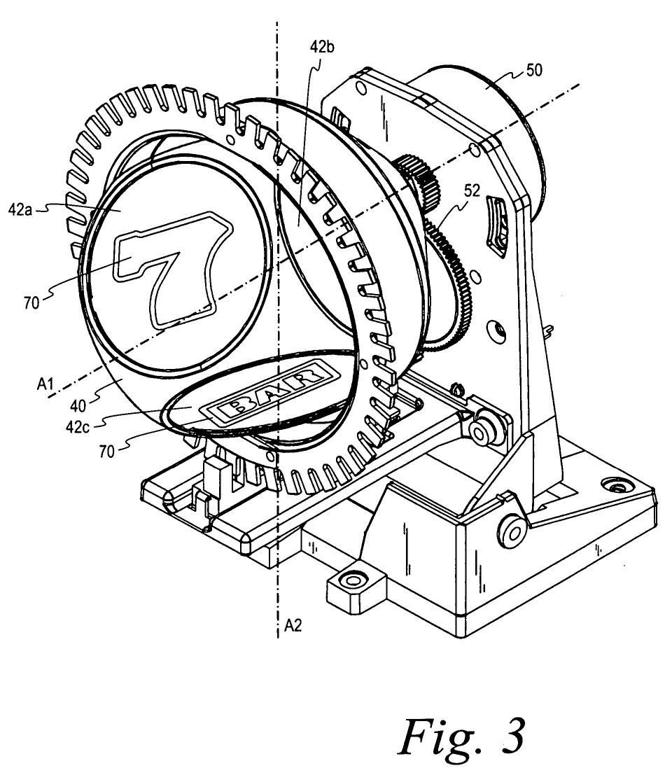

Turning to FIG. 3, the gaming machine 10 also includes at least one rotatable body 40 preferably supported by the housing 11 of the gaming machine 10. The body 40 is shown in a preferred configuration as a cube or die, but can take on a wide variety of three-dimensional shapes including a sphere, a pyramid, or other polyhedron. The body 40 has a plurality of externally visible surfaces, or faces 42a,b,c. Although it is preferred that the body 40 have six faces 42 that correspond with the six sides of a cube, the body 40 may have more or less faces 42a,b,c depending on the configuration of the body 40. Other polyhedrons will have varying numbers of faces 42 on the body 40. Further, if the body 40 is a sphere, it may have only one curved surface 42 which extends around and comprises the entire outer surface area of the sphere. Moreover, the body 40 may take on an irregularly shaped configuration having one continuous curved surface 42. The body 40 further bears a plurality of symbols 70, preferably located on the various faces 42a,b,c of the body 40. In one embodiment, the symbols 70 on the faces 42 of the body 40 correspond to the symbols 70 used in a basic game of the gaming machine 10.

The body 40 is rotatable around at least a first axis A1, and preferably is also rotatable around a second axis A2. In the most preferred embodiment, the axes A1,A2 are perpendicular to one another. The body 40 is actuated and rotated about both of the axes A1,A2 by an actuator 50, which in a preferred embodiment comprises at least a motor. The actuator 50 may operate and rotate the body 40 either directly, or through a number of transmission systems 52 including belts, gears, linkages, etc. All that is required is that the actuator 50 be operatively connected to the body 40 so as to cause the body 40 to rotate about one or more of the axes A1,A2 and display the various symbols 70 on the faces 42a,b,c of the object 40. It should also be recognized by those skilled in the art that one or more actuators 50 may be utilized to actuate one or more bodies 40. In the most preferred embodiment, each body 40 is actuated by an individual actuator 50, such that each body 40 and its actuator 50 comprise a distinct unit. The body 40 is preferably mounted on the housing 11 in a manner such that when the body 40 is rotated, only one of the faces 42, and thus only one of the symbols 70, is completely displayed to the player. In this way, each rotatable body 40 acts to display a face 42a,b,c bearing a symbol 70 to the player.

In FIG. 4, a first embodiment of the gaming machine 10 includes a basic game which is a slot game visible on the primary display 12. The slot game includes three reels 60a,b,c, each bearing a plurality of symbols 70. The symbols 70 include standard symbols 72 and second-chance symbols 74. In this embodiment, the symbols 70 include six standard symbols 72 (bar, double-bar, triple-bar, 7, cherry, and wild) and one second-chance symbol 74 (a blank). The standard symbols 72 may take on virtually any symbol, the combination of which may be used to display certain winning outcomes, which correspond to certain payouts in a paytable. The second-chance symbol 74 may also be virtually any symbol, for example a “Wild Dice” symbol, but is not one of the standard symbols 72 used in the basic game. Additionally, as in this embodiment, the second-chance symbol 74 may be a blank, which is no symbol at all. The gaming machine 10 also includes three rotatable bodies 40a,b,c supported by the housing 11, preferably located above the primary display 12. As seen in FIG. 4, the bodies 40a,b,c are preferably cubes or dice having six faces 42 each. Each face 42 of each body 40 bears one of the standard symbols 72 from the basic game.

During play of the gaming machine 10, the basic slot game is executed on the primary display 12 in a traditional fashion. A player inserts a wager into the machine 10, and executes a play of the machine 10, as described herein. The reels 60a,b,c stop to display combinations of symbols 70 on a payline 13, of which some are winning combinations which are rewarded with a payout. In this embodiment, if a winning outcome of the basic game results in a second-chance symbol 74 stopping on a payline 13, the rotatable body 40 associated with the reel 60 bearing the second-chance symbol 74 begins to rotate. In this embodiment, the body 40 associated with a particular reel 60 is the body 40 above that reel 60. When the object 40 stops rotating, a standard symbol 72 on the body 40 is displayed, which is used in combination with the other standard symbols 72 on the payline 13 to determine and display a second-chance combination, for which certain winning outcomes exist in accordance with a paytable on the gaming machine 10. For example in FIG. 4, as the reels 60 in the basic game are stopped, the second reel 60b bears a “Seven” symbol while the first and third reels 60a,c bear blanks, which in this embodiment are second-chance symbols 74. The bodies 40a,c above the first and third reels 60a,c begin to rotate, and are stopped to display standard symbols 72. As an additional feature, lights 56 around the bodies 40a,c may be activated to indicate that the bodies 40a,c are in play. In this case, the bodies 40a,c, stop to reveal “Seven” symbols. Because three “Seven” symbols on the payline 13 of the three reels 60a,b,c is a winning outcome of the basic game, the “Seven” symbols on the bodies 40a,c serve as substitute symbols for the second-chance symbols 74 (blanks) to complete the winning combination, and the player is rewarded according to the paytable. In this way, the standard symbols 72 on the bodies 40a,c are used in combination with the standard symbol 72 on the second reel 60b to form a winning combination. It should be recognized that the standard symbols 72 on the bodies 40a,b,c may or may not land on a combination which is a winning combination with the standard symbols 72 on the reels 60a,b,c.

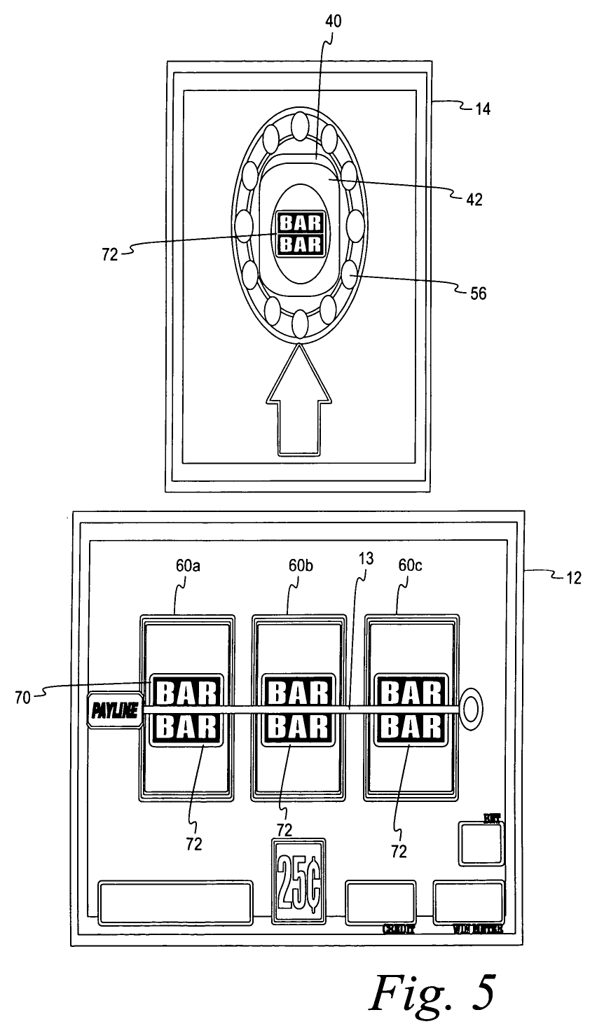

In FIG. 5, a second embodiment of the gaming machine 10 includes one rotatable body 40, which is a cube having six faces 42, each face 42 displaying at least one symbol 70 which is preferably a standard symbol 72. The gaming machine 10 also includes a primary display 12 which displays a basic wagering game. In this embodiment, the basic wagering game is a slot game having three reels 60a,b,c, each reel 60a,b,c having a plurality of symbols 70 displayed about the circumference of the reel 60a,b,c. The symbols 70 on the reels 60a,b,c are all standard symbols 72 and do not include any second-chance symbols 74. When the basic game is played, the reels 60 spin and come to rest with a certain combination of standard symbols 72 displayed on the payline 13. Either at the same time that the reels 60 are spinning, or at a different time, the body 40 is rotated about one or more axes A1,A2. The body 40 comes to rest with one face 42, and thus one standard symbol 72 facing the player. The standard symbol 72 on the body 40 is used in combination with the standard symbols 72 on the payline 13 of the basic game to provide additional combinations and possible winning outcomes, if any. For example, as seen in FIG. 5, three “double-bar” standard symbols 72 have landed on the payline 13 in the basic game. In this embodiment, the three matching “double-bar” symbols 72 are a winning combination for which a certain payout is awarded to the player. Additionally, the body 40 has stopped rotating to display the face 42 bearing a “double bar” standard symbol 72, which matches the standard symbols 72 on the reels 60. As such, an additional winning outcome is achieved, and a bonus award is awarded to the player.

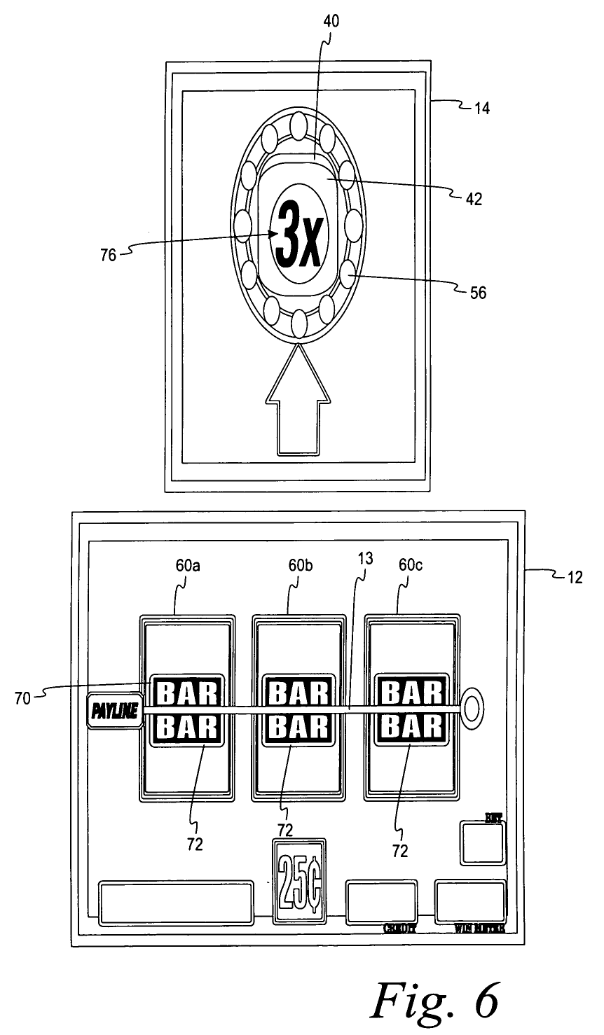

In FIG. 6, a third embodiment of the gaming machine 10 includes one rotatable body 40, which is a cube having six faces 42, each face 42 displaying at least one symbol 70. In this embodiment, each of the symbols 70 on the faces 42 of the body 40 are enhanced award symbols 76. Enhanced award symbols 76 are symbols such as multipliers, credit amounts, free spins, or other non-monetary prizes. Non-monetary prizes are any award which is not cash, currency, or credit for cash, and includes, but is not limited to, casino gifts, services, collector item's meals, drinks, hotel stays, vacations, etc. Thus, unlike standard symbols 72 which are used in combination to create winning outcomes, enhanced award symbols 76 provide awards to a player based upon the award, value or other text displayed on the symbol 76. The gaming machine 10 also includes a primary display 12 which displays a basic wagering game. In this embodiment, the basic wagering game is a slot game having three reels 60a,b,c, each reel 60a,b,c having a plurality of symbols 70 displayed about the circumference of the reel 60a,b,c. The symbols 70 on the reels 60a,b,c are preferably all standard symbols 72 and do not include any second-chance symbols 74. When the basic game is played, the reels 60 spin and come to rest with a certain combination of standard symbols 72 displayed on the payline 13. Either at the same time that the reels 60 are spinning, or at a different time, the body 40 is rotated about one or more axes A1,A2 and stopped such that an enhanced award symbol 76 faces the player. The enhanced award symbol 76 on the body 40 is awarded to the player provided that the standard symbols 72 on the payline 13 of the basic game constitute a winning outcome. For example, as seen in FIG. 6, three “double-bar” standard symbols 72 have landed on the payline 13 in the basic game. In this embodiment, the three matching “double-bar” symbols 72 are a winning combination for which a certain payout is awarded to the player. Additionally, the body 40 has stopped rotating to display the face 42 bearing a “3 times multiplier” enhanced award symbol 76. As such, an additional winning outcome is achieved, and the credit amounts awarded to the player for the matching three “double-bar” symbols are multiplied by the “3 times multiplier” and awarded to the player.

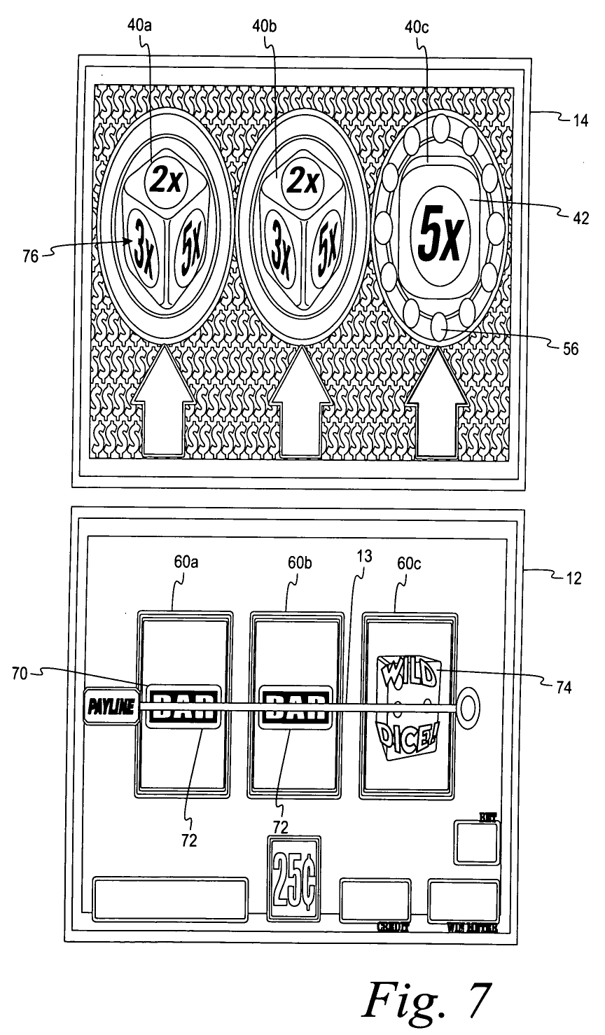

An alternate configuration of the third embodiment of the gaming machine 10 is depicted in FIG. 7. The gaming machine 10 includes three rotatable bodies 40a,b,c, which are cubes having six faces 42, each face 42 displaying at least one symbol 70. In this alternate embodiment, each of the symbols 70 on the faces 42 of the bodies 40 are enhanced award symbols 76, which are preferably multipliers. The gaming machine 10 also includes a primary display 12 which displays a basic wagering game. In this embodiment, the basic wagering game is a slot game having three reels 60a,b,c, each reel 60a,b,c having a plurality of symbols 70 displayed about the circumference of the reel 60a,b,c. The symbols 70 on the reels 60a,b,c preferably include standard symbols 72 and at least one second-chance symbol 74, which in this alternate embodiment is a “Wild Dice” symbol. When the basic game is played, the reels 60 spin and come to rest with a certain combination of standard symbols 72 and/or second-chance symbols 74 displayed on the payline 13. If a second-chance symbol 74 occurs on the payline 13, it is used to complete a winning combination. As seen in FIG. 7, two “single-bar” standard symbols 72 have landed on the payline 13 along with one “Wild Dice” second-chance symbol 74. The second-chance symbol 74 acts as a “wild” to complete the payline of three “single-bar” symbols. Thus, the player is awarded the credits associated with three “single-bar” symbols. Because the second-chance symbol 74 occurred as part of a winning combination of the basic game, the bodies 40a,b,c are activated. Either at the same time that the reels 60 are spinning, or at a different time, the bodies 40a,b,c are rotated about one or more axes A1,A2. The player makes a selection of one of the bodies 40a,b,c and the selected body 40c comes to a stop to display an enhanced award symbol 76 to the player. The enhanced award symbol 76 on the selected body 40c, in this case a “5 times multiplier,” is awarded to the player provided that the combination of standard symbols 72 and second-chance symbols 74 on the payline 13 of the basic game constitute a winning outcome.

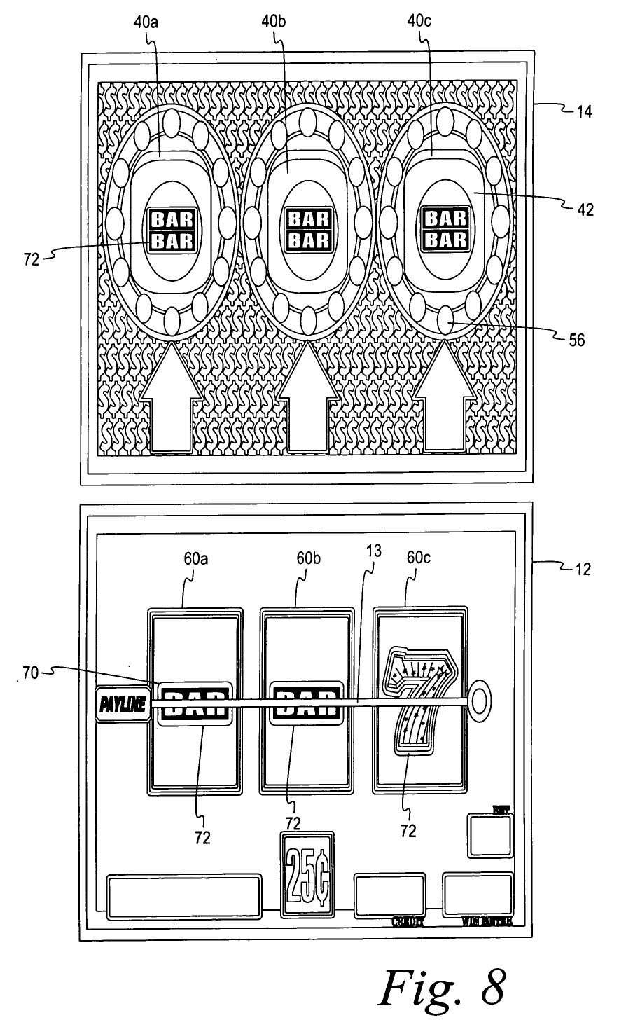

In FIG. 8, a fourth embodiment of the gaming machine 10 includes three rotatable bodies 40a,b,c which are cubes having six faces 42, each face 42 displaying at least one symbol 70. In this embodiment, all of the symbols 70 on the faces 42 of the bodies 40 are standard symbols 72. The gaming machine 10 also includes a primary display 12 which displays a basic wagering game. In this embodiment, the basic wagering game is a slot game having three reels 60a,b,c, each reel 60a,b,c having a plurality of symbols 70 displayed about the circumference of the reel 60a,b,c. The symbols 70 on the reels 60a,b,c are preferably all standard symbols 72 and do not include any second-chance symbols 74. When the basic game is played, the reels 60 spin and come to rest with a certain combination of standard symbols 72 displayed on the payline 13. Either at the same time that the reels 60 are spinning, or at a different time, the bodies 40a,b,c are rotated about one or more axes A1,A2 and stopped such that three standard symbols 72 face the player. The standard symbols 72 on the bodies 40a,b,c, and the standard symbols 72 on the payline 13 of the basic game are each evaluated for winning outcomes, and any awards are awarded to the player. For example, as seen in FIG. 8, two “single-bar” standard symbols 72 and one “Seven” standard symbol 72 have landed on the payline 13 of the basic game, which in this embodiment, does not constitute a winning combination. Thus, the play of the basic game does not result in a winning outcome for which an award is granted. However, the three bodies 40 have stopped rotating such that three “double-bar” standard symbols 72a,b,c are facing the player. In this embodiment, the three matching “double-bar” symbols 72 on the bodies 40 are a winning combination for which a certain payout is awarded to the player. In a variation of this embodiment, if a combination of symbols 72a,b,c on the bodies 40 match, compliment, or are associated with a combinations of standard symbols 72 on the payline 13 of the basic game, yet another bonus award is awarded to the player. Numerous variations to the embodiments described herein exist without departing from the spirit of the invention, and will be obvious to those skilled in the art.

The present invention provides a display mechanism for a gaming machine that has substantial advantages over traditional display mechanisms. The rotatable bodies 40 described herein provide an improved form of entertainment to players of gaming machines 10 in that the actuation of the mechanical bodies 40 provides additional suspense. The use of standard symbols 72 from the basic game on the bodies 40 expands the amount, nature, and frequency of winning combinations which the gaming machine 10 can produce. Furthermore, the entertainment value is greatly enhanced by the spinning or rotation of the bodies 40, and their use in combination with, or in addition to, the reels 60 of the basic game. The “second chance” feature employing the second-chance symbols 74 also greatly increases the appeal of the gaming machine 10 by providing the player opportunities to achieve additional winning combinations, regardless of whether he or she was successful in playing the basic game.

Each of these embodiments and obvious variations thereof is contemplated as falling within the spirit and scope of the claimed invention, which is set forth in the following claims.

What is claimed is:

1. A gaming machine comprising:
a housing;
a display coupled to the housing, the display displaying a wagering game having a plurality of symbols; and
at least one rotatable body coupled to the housing, the body bearing at least one of the symbols from the game.

2. The gaming machine of claim 1, wherein the body is a cube, and the at least one of the symbols from the game is affixed to a face of the cube.

3. The gaming machine of claim 1, wherein the game is video poker.

4. The gaming machine of claim 1, wherein the game is a slot game.

5. The gaming machine of claim 4, wherein the game comprises a plurality of reels, wherein the plurality of symbols are located on the reels.

6. The gaming machine of claim 5, wherein at least one of the plurality of symbols on the reels is a second-chance symbol.

7. The gaming machine of claim 6, wherein the second-chance symbol is associated with the at least one body.

8. The gaming machine of claim 1, wherein the symbols in the game include a plurality of standard symbols and at least one second-chance symbol.

9. The gaming machine of claim 8, wherein the second-chance symbol depicts the shape of the body.

10. The gaming machine of claim 9, wherein the body is a cube.

11. The gaming machine of claim 9, wherein the body is a dice.

12. The gaming machine of claim 8, wherein the second-chance symbol is a blank.

13. A gaming machine comprising:
a housing;
a display coupled to the housing, the display displaying a wagering game having a plurality of standard symbols and at least one second-chance symbol; and
at least one rotatable body coupled to the housing, the body rotatable about a plurality of axes, the body bearing at least one of the symbols from the game.

14. The gaming machine of claim 13, wherein the body is a cube.

15. The gaming machine of claim 13, wherein the body bears all of the standard symbols of the game.

16. The gaming machine of claim 13, wherein the body has a plurality of faces, wherein each face bears one standard symbol.

17. The gaming machine of claim 13, wherein the body has a plurality of faces, wherein each face bears only one standard symbol.

18. The gaming machine of claim 13, wherein the body has a plurality of faces, and the number of faces equal the number of standard symbols in the game.

19. The gaming machine of claim 13 having a plurality of bodies, wherein each body bears at least one of the standard symbols in the game.

20. The gaming machine of claim 19, wherein each body has a plurality of faces, and each face bears one standard symbol.

21. The gaming machine of claim 20, wherein the wagering game is a slot game comprising a plurality of reels, where the standard symbols are located on the reels.

22. The gaming machine of claim 21, wherein the number of reels is equal to the number of bodies.

23. A gaming machine comprising:
a housing;
a display coupled to the housing, the display displaying a wagering game having a plurality of standard symbols; and
at least one rotatable body coupled to the housing, the body rotatable about a plurality of axes, the body bearing at least one enhanced award symbol.

24. The gaming machine of claim 23, wherein the body has a plurality of faces, and each face bears at least one enhanced award symbol.

25. The gaming machine of claim 23 having a plurality of bodies, wherein each body bears at least one enhanced award symbol.

26. The gaming machine of claim 25, wherein the enhanced award symbol is a multiplier.

27. The gaming machine of claim 25, wherein the enhanced award symbol is selected from the group consisting of credit amounts, free spins, and non-monetary prizes.

28. A method of conducting a wagering game on a gaming machine, the gaming machine having a housing, the method comprising:
receiving a wager;
displaying a slot game, the game having a plurality of reels and at least one payline, the reels having a plurality of symbols; and
providing at least one rotatable body coupled to the housing, the body rotatable about a plurality of axes, the body bearing at least one of the plurality of symbols of the game.

29. The method of claim 28, further comprising the steps of executing a play of the slot game, determining whether the symbols landing on the payline constitute a winning combination, and awarding an award associated with the winning combination.

30. The method of claim 29, further comprising the step of determining whether any of the symbols on the payline are a second-chance symbol, and if so, actuating the body, and stopping the body to display one of the symbols on the body.

31. The method of claim 30, further comprising the steps of determining whether the combination of the symbols landing on the payline and the symbol displayed on the body constitute a winning combination, and if so, awarding an award associated with the winning combination.

32. A method of conducting a wagering game on a gaming machine, the gaming machine having a housing, the method comprising:
receiving a wager;
displaying a slot game, the game having a plurality of reels and at least one payline, the reels having a plurality of standard symbols and at least one second-chance symbols, and
providing a plurality of rotatable bodies coupled to the housing, each of the bodies rotatable about a plurality of axes, each of the bodies bearing a plurality of symbols.

33. The method of claim 32, wherein the number of reels and the number of bodies are equal.

34. The method of claim 32, further comprising the steps of executing a play of the slot game, determining whether the symbols landing on the payline constitute a winning combination, and awarding an award associated with the winning combination.

35. The method of claim 34, further comprising the step of determining whether any second-chance symbol on any of the reels has landed on the payline, and if so, actuating the body associated with said reel, and stopping the body to display one symbols on the body.

36. The method of claim 35, further comprising the steps of determining whether the combination of the symbols landing on the payline and the symbol on the body constitute a winning combination, and if so, awarding an award associated with the winning combination.

37. A method of conducting a wagering game on a gaming machine, the gaming machine having a housing, the method comprising:
receiving a wager;
displaying a slot game, the game having a plurality of reels and at least one payline, the reels having a plurality of symbols; and
providing at least one rotatable body coupled to the housing, the body rotatable about a plurality of axes, the body bearing a plurality of enhanced award symbols.

38. The method of claim 37, wherein the enhanced award symbol is a multiplier.

39. The method of claim 37, wherein the enhanced award symbol is selected from the group consisting of credit amounts, free spins, and non-monetary prizes.

40. The method of claim 37, further comprising the steps of executing a play of the slot game, determining whether the symbols landing on the payline constitute a winning combination, and awarding an award associated with the winning combination.

41. The method of claim 40, further comprising the steps of actuating the body, stopping the body to display at least one enhanced award symbol, and awarding the enhanced award associated with the enhanced award symbol displayed.

42. The method of claim 37, wherein the number of bodies equals the number of reels.

43. The method of claim 42, further comprising the steps of executing a play of the slot game, determining whether the symbols landing on the payline constitute a winning combination, and awarding an award associated with the winning combination.

44. The method of claim 43, further comprising the steps of receiving a selection of one of the bodies, actuating the selected body, stopping the body to display at least one enhanced award symbol, and awarding the enhanced award associated with the enhanced award symbol displayed.
